(19) United States
(12) Patent Application Publication
(10) Pub. No.: US 2025/0161760 A1
(43) Pub. Date: May 22, 2025

(54) GOLF BALL

(71) Applicant: Bridgestone Sports Co., Ltd., Tokyo (JP)

(72) Inventor: Jun SHINDO, Chichibushi (JP)

(73) Assignee: Bridgestone Sports Co., Ltd., Tokyo (JP)

(21) Appl. No.: 18/947,408

(22) Filed: Nov. 14, 2024

(30) Foreign Application Priority Data
Nov. 17, 2023 (JP) 2023-195997

(51) Int. Cl. A63B 37/00; C08K 5/13; C08K 9/06; C08L 9/00; C08L 15/00; C08L 75/04

(52) U.S. Cl. CPC A63B 37/0074; A63B 37/0082; A63B 37/0084; C08K 5/13; C08K 9/06; C08L 9/00; C08L 15/00; C08L 75/04; C08L 2201/08; C08L 2205/16; C08L 2207/53; C08L 2312/00

(57) ABSTRACT

In a golf ball having a core and a cover of at least one layer encasing the core, the core is formed of a rubber composition which includes (a) a base rubber, (b) a co-crosslinking agent which is an α,β-unsaturated carboxylic acid and/or a metal salt thereof, (c) a filler, and (d) a crosslinking initiator, and the base rubber (a) has a polybutadiene content of at least 90 wt % and a syndiotactic 1,2-polybutadiene content of from 5 to 30 wt %, the amount of filler (c) included is from 6 to 14 vol % of the rubber composition, and the ball has a specific gravity of 1.0 or more and an initial velocity of 75 m/s or less, as the result of which the golf ball maintains a low rebound, undergoes little change in properties due to changes in temperature and has an excellent durability.

### CROSS-REFERENCE TO RELATED APPLICATIONS

This non-provisional application claims priority under 35 U.S.C. § 119(a) on Patent Application No. 2023-195997 filed in Japan on Nov. 17, 2023, the entire contents of which are hereby incorporated by reference.

### TECHNICAL FIELD

The present invention relates to golf balls such as practice golf balls that have a core made of a low-resilience rubber composition and a cover.

### BACKGROUND ART

Low-rebound golf balls, as typified by practice golf balls, have a low rebound compared with golf balls intended for regulation play (game balls). When used on a practice range or the like, a low-rebound ball is prevented from flying off the range and is able in a limited space to reproduce a trajectory similar to that of a game ball. Various types of golf balls, including one-piece balls and two-piece balls, have hitherto been described in which a rubber composition obtained by mixing methacrylic acid and zinc oxide together with polybutadiene rubber as the base material is molded and this molded rubber composition is used as a component of the ball. JP-A S48-81951, JP-A S60-92780 and JP-A 2012-228470 describe methods which add a low-resilience rubber such as styrene-butadiene rubber (SBR), isoprene rubber (IR) or butyl rubber to obtain golf balls having an even lower rebound.

However, because the methacrylic acid included in such rubber compositions has an unpleasant odor and corrodes metal parts of the production equipment, it is unwelcome on the production site. Instead, methods which use a metal salt such as zinc acrylate as the curing agent in rubber compositions for game balls show promise. In such cases, when a metal salt such as zinc acrylate is used in the rubber composition, the molded product ends up having too high a rebound compared with when methacrylic acid is used. To lower the rebound to the necessary level, it has been necessary to add additional low-resilience rubber. As a result, when the ball is used in a low-temperature environment such as in winter, it exhibits a large decrease in rebound and a considerable rise in hardness, leading to drawbacks such as a reduced distance and a poor feel when utilized on a practice range.

### SUMMARY OF THE INVENTION

It is therefore an object of the present invention to provide a golf ball which maintains a low rebound, undergoes little change in physical properties with temperature changes, and has an excellent durability.

As a result of intensive investigations, I have discovered that, in a golf ball such as a practice golf ball for which a low rebound is desired, by having the rubber composition making up the core include (a) a base rubber, (b) an α,β-unsaturated carboxylic acid and/or a metal salt thereof as a co-crosslinking agent, (c) a filler and (d) a crosslinking initiator, such that the base rubber (a) has a polybutadiene content of at least 90 wt % and a syndiotactic 1,2-polybutadiene content of from 5 to 30 wt %, by preparing the composition such that the amount of filler (d) included is from 6 to 14 vol % of the rubber composition, and also by adjusting the specific gravity of the ball to 1.0 or more and the initial velocity of the ball to 75 m/s or less, the ball maintains a low rebound, achieves a stable trajectory and feel on a practice range regardless of the air temperature, and is able to exhibit a stable ball performance regardless of the ambient temperature.

Accordingly, the invention provides a golf ball having a core and a cover of at least one layer encasing the core, wherein the core is formed of a rubber composition which includes (a) a base rubber, (b) a co-crosslinking agent which is an α,β-unsaturated carboxylic acid and/or a metal salt thereof, (c) a filler, and (d) a crosslinking initiator. The base rubber (a) has a polybutadiene content of at least 90 wt % and a syndiotactic 1,2-polybutadiene content of from 5 to 30 wt %, the amount of filler (c) included is from 6 to 14 vol % of the rubber composition, and the ball has a specific gravity of 1.0 or more and an initial velocity of 75 m/s or less.

In a preferred embodiment of the golf ball of the invention, the ball has a difference between the initial velocities at 0° C. and 24° C. of 2.0 m/s or less.

In another preferred embodiment of the inventive golf ball, the filler (c) is an inorganic filler. The inorganic filler may be one or more selected from the group consisting of zinc oxide, barium sulfate, calcium carbonate and silicon dioxide (silica). Preferably, the inorganic filler is silicon dioxide (silica) and further includes a silane coupling agent. The silane coupling agent may be an alkoxy group-containing silane coupling agent.

In still another preferred embodiment, the base rubber (a) includes a silane-modified diene rubber.

In yet another preferred embodiment, the rubber composition further includes (e) a hindered phenol-type antioxidant.

In a further preferred embodiment, the cover has an outermost layer that is formed of a resin composition composed primarily of a urethane resin or an ionomer resin.

In a still further preferred embodiment, the golf ball is a two-piece golf ball having a single-layer core and a single-layer cover, wherein the cover is formed of a urethane resin and the core is a halogenation-treated core.

In a yet further preferred embodiment, the syndiotactic 1,2-polybutadiene includes syndiotactic 1,2-polybutadiene having a melting point of 150° C. or more.

In an additional preferred embodiment, the syndiotactic 1,2-polybutadiene is dispersed in a fibrous manner within the core.

### ADVANTAGEOUS EFFECTS OF THE INVENTION

The golf ball of the invention has a low rebound, undergoes little change in properties with changes in temperature and has an excellent durability, in addition to which it has a stable trajectory and feel at impact regardless of the air temperature at a practice range. Also, even in cases where a low-distance golf ball must be selected for play according to special rules, it is capable of exhibiting a stable ball performance regardless of the ambient temperature. In addition, in the golf ball manufacturing process, because methacrylic acid is not included within the rubber composition, the working environment can be improved due to odor amelioration and the man-hours and costs associated with equipment maintenance due to corrosion can be reduced.

### DETAILED DESCRIPTION OF THE INVENTION

The objects, features and advantages of the invention will become more apparent from the following detailed description.

The golf ball of the invention has a core and a cover of at least one layer encasing the core. The core is formed of a composition which includes components (a) to (d) below:
(a) a base rubber,
(b) a co-crosslinking agent which is an α,β-unsaturated carboxylic acid and/or a metal salt thereof,
(c) a filler, and
(d) a crosslinking initiator.

Syndiotactic 1,2-polybutadiene is included in the base rubber serving as component (a). By including a given amount of highly crystalline syndiotactic 1,2-polybutadiene within the base rubber, the resilience of the base rubber can be efficiently lowered.

The syndiotactic 1,2-polybutadiene used may be a commercially available product, such as a product obtained as a composite of syndiotactic 1,2-polybutadiene dispersed within cis-1,4-polybutadiene or a product consisting of syndiotactic 1,2-polybutadiene proper. Specific examples include those available under the trade name UBEPOL VCR from UBE Elastomer Co., Ltd. and those available under the trade names RB810, RB820, RB830 and RB840 from ENEOS Material.

The content of syndiotactic 1,2-polybutadiene is from 5 to 30 wt %, preferably from 6 to 20 wt %, per 100 wt % of the base rubber. Within this range, a low core rebound is maintained and changes in the properties of the core due to changes in temperature are minimized.

One, two or more type of syndiotactic 1,2-polybutadiene may be used. It is preferable to use a syndiotactic 1,2-polybutadiene having a melting point of 150° C. or more. In addition, it is desirable for the above syndiotactic 1,2-polybutadiene to be dispersed in a fibrous manner within the molded rubber product (core) obtained by molding the rubber composition.

The polybutadiene other than the above syndiotactic 1,2-polybutadiene is exemplified by high-cis polybutadiene having a cis-1,4-bond content of at least 60%, preferably at least 80%, more preferably at least 90%, and most preferably at least 95%. The high-cis polybutadiene used may be one synthesized using a rare-earth catalyst or a Group VIII metal compound catalyst.

The polybutadiene overall accounts for at least 90 wt %, preferably at least 95 wt %, of the base rubber (a). It is most preferable for all of the base rubber to be polybutadiene.

Rubbers other than polybutadiene, such as styrene-butadiene rubber (SBR), natural rubber, polyisoprene rubber or ethylene-propylene-diene rubber (EPDM) may be included in the base rubber. One of these may be used alone or two or more may be used together.

The base rubber may include a diene rubber modified with an alkoxysilane or other silane compound, that is, a silane-modified diene rubber. In addition, by including silica as the subsequently described filler in this silane-modified diene rubber, a rubber molded product (core) whose rebound has been lowered even more can be easily obtained.

Next, component (b) is a co-crosslinking agent which is an α,β-unsaturated carboxylic acid and/or a metal salt thereof. The number of carbon atoms on this unsaturated carboxylic acid is preferably from 3 to 8. Specific examples include unsaturated carboxylic acids such as acrylic acid, methacrylic acid, maleic acid and fumaric acid. Specific metals that may form salts with these unsaturated carboxylic acids include zinc, sodium, magnesium, calcium and aluminum. Zinc is especially preferred. Hence, zinc acrylate is most preferred as the co-crosslinking agent.

The content of component (b) per 100 parts by weight of the base rubber serving as component (a) is preferably at least 5 parts by weight, more preferably at least 10 parts by weight, and even more preferably at least 15 parts by weight. The upper limit is preferably 40 parts by weight or less, more preferably 35 parts by weight or less, and even more preferably 30 parts by weight or less. At a content lower than the above range, the molded core becomes too soft and the rebound becomes significantly worse than the low rebound desired. At a content higher than the above range, the rebound rises and the feel at impact may worsen.

Examples of inorganic fillers that can be favorably used as the filler (c) include zinc oxide, barium sulfate, calcium carbonate and silicon dioxide (silica). One of these may be used alone or two or more may be used in combination. The filler (c) is suitably selected so as to, taking into account the specific gravity inherent to that substance, fall within the subsequently described range in the volumetric ratio. In cases where silicon dioxide (silica) is used as the inorganic filler, an alkoxysilane compound or other silane coupling agent may additionally be used together.

The filler content is preferably adjusted within a range of from 6 to 14 vol % of the rubber composition. At more than 14 vol % of the rubber composition, the physical properties of the core with respect to temperature changes are greatly influenced and the feel at impact worsens. On the other hand, when the content is less than 6 vol % of the rubber composition, the target ball rebound may be exceeded. The volume ratio (%) of the filler can be calculated from the specific gravity and content of the filler substance that is used.

Component (d) is a crosslinking initiator. It is preferable for this crosslinking initiator to be an organic peroxide, and especially preferable to use an organic peroxide having a one-minute half-life temperature of between 110° C. and 180° C. Examples of such organic peroxides include dicumyl peroxide (Percumyl D, from NOF Corporation), 2,5-dimethyl-2,5-di(t-butylperoxy)hexane (Perhexa 25B, from NOF Corporation) and di(2-t-butylperoxyisopropyl)benzene (Perbutyl P, from NOF Corporation). The use of dicumyl peroxide is preferred. Other commercial products that may be used include Perhexa C-40, Nyper BN and Peroyl L (all from NOF Corporation), and Luperco 231XL (from AtoChem Co.). These may be used singly or two or more may be used in combination.

The content of component (d) per 100 parts by weight of the base rubber is preferably at least 0.1 part by weight, and more preferably at least 0.3 part by weight. The upper limit is preferably 5 parts by weight or less, more preferably 4 parts by weight or less, and even more preferably 3 parts by weight or less.

An antioxidant may additionally be used as component (e) in this invention. Specific examples include hindered phenol-type antioxidants such as 2,6-di-tert-butyl-4-methylphenol, 2,6-di-tert-butyl-4-ethylphenol, 2,2′-methylenebis(4-methyl-6-tert-butylphenol), pentaerythritol tetrakis[3-(3,5-di-tert-butyl-4-hydroxyphenyl)propionate] and 1,3,5-tris(3′,5′-di-t-butyl-4-hydroxybenzyl)isocyanuric acid. Examples of commercial products include Nocrac 200, Nocrac M-17 and Nocrac NS-6 (all from Ouchi Shinko Chemical Industry Co., Ltd.), Irganox 1010 (from BASF) and ADK STAB AO-20 (from Adeka Corporation). These may be used singly or two or more may be used in combination. The content of this antioxidant per 100 parts by weight of the base rubber is not particularly limited, but is preferably at least 0.05 part by weight, and more preferably at least 0.1 part by weight; and is preferably not more than 3.0 parts by weight, more preferably not more than 2.0 parts by weight, and even more preferably not more than 1.5 parts by weight. When the content is too high or too low, a suitable core hardness gradient may not be obtained, as a result of which a good rebound, durability and spin rate-lowering effect on full shots may not be obtained.

In addition to the above components (a) to (d) and (e), other additives such as sulfur, organosulfur compounds and processing aids may be included so long as they do not detract from the advantageous effects of the invention.

A commercial product may be used as the sulfur. Examples of such products that can be used include Sulfax® 5 from Tsurumi Chemical Industry Co., Ltd., Sanmix S-80N and Sanmix IS-60N from Sanshin Chemical Industry Co., Ltd., and Akroform® S-80/EPR-P from Akrochem Corporation. To increase the dispersibility of a very small amount of sulfur, it is desirable to use the sulfur in the form of a masterbatch. Examples of such sulfur masterbatches include those available under the above trade names Sanmix S-80N and Sanmix IS-60N from Sanshin Chemical Industry Co., Ltd., and that available under the above trade name Akroform® S-80/EPR/P from Akrochem Corporation.

The sulfur content is not particularly limited, but is preferably at least 0.01 part by weight, more preferably at least 0.03 part by weight, and most preferably at least 0.05 part by weight, per 100 parts by weight of the above rubber component. The upper limit is preferably 5.0 parts by weight or less, more preferably 2.0 parts by weight or less, and most preferably 1.0 part by weight or less. When the sulfur content is too high, crosslinking reactions by the organic peroxide are hindered due to the influence of the sulfur, as a result of which the overall hardness of the molded product tends to soften considerably.

The organosulfur compound is exemplified by, without particular limitation, thiophenols, thionaphthols, diphenylpolysulfides, halogenated thiophenols and metal salts of these. Specific examples include zinc salts of pentachlorothiophenol, pentafluorothiophenol, pentabromothiophenol and p-chlorothiophenol, and the following having from 2 to 4 sulfur atoms: diphenyl polysulfides, dibenzyl polysulfides, dibenzoyl polysulfides, dibenzothiazoyl polysulfides and dithiobenzoyl polysulfides. These may be used singly or two or more may be used in combination. Of these, the use of diphenyldisulfide and/or the zinc salt of pentachlorothiophenol is especially preferred.

It is recommended that the organosulfur compound content per 100 parts by weight of the base rubber be preferably at least 0.05 part by weight, more preferably at least 0.1 part by weight, and even more preferably at least 0.2 part by weight, and that the upper limit be preferably 3 parts by weight or less, more preferably 2 parts by weight or less, and still more preferably 1 part by weight or less. When the organosulfur compound content is too high, the rubber composition molded under heat from the rubber composition may become too soft; on the other hand, when the content is too low, an increase in the rebound may become unlikely.

A higher fatty acid or a metal salt thereof may be suitably used as a processing aid. Examples of higher fatty acids include stearic acid, palmitic acid, oleic acid, linoleic acid, linolenic acid and myristic acid, Stearic acid is especially preferred. Examples of metal salts of higher fatty acids include lithium salts, sodium salts, potassium salts, copper salts, magnesium salts, calcium salts, strontium salts, barium salts, tin salts, cobalt salts, nickel salts, zinc salts and aluminum salts. The use of zinc stearate is especially preferred. The processing aid content per 100 parts by weight of the base rubber may be set to preferably at least 1 part by weight, more preferably at least 3 parts by weight, and even more preferably at least 5 parts by weight. The upper limit in this content per 100 parts by weight of the base rubber is preferably 20 parts by weight or less, more preferably 15 parts by weight or less, and even more preferably 10 parts by weight or less. When this content is too high, a sufficient hardness or rebound may not be obtained; when it is too low, the added chemicals may not fully disperse and so the expected properties may not be obtained. Methods for adding the processing aid include, but are not particularly limited to, that of charging the processing aid into a mixer at the same time as the other chemicals, that of adding the processing aid after first mixing it with other chemicals such as component (b), that of coating the processing aid onto the surface of other chemicals such as component (b) or adding it as a binder for those chemicals, and that of preparing beforehand a masterbatch of the processing aid together with component (a) and then adding the masterbatch.

The core can be produced by vulcanizing and curing the rubber composition containing the above ingredients. For example, the core can be produced by using a Banbury mixer, roll mill or other mixing apparatus to intensively mix the rubber composition, subsequently compression molding or injection molding the mixture in a core mold, and curing the resulting molded body by suitably heating it under conditions sufficient to allow the organic peroxide or co-crosslinking agent to act, such as at a temperature of between about 100° C. and about 200° C. for 10 to 40 minutes.

The above core may be one that has been subjected to halogenation treatment. By using this halogenation treated core, when a urethane resin such as a thermoplastic polyurethane elastomer is employed as the subsequently described cover material, adhesion between the core and cover is increased, enabling an excellent ball durability to be obtained. Reference can be made to JP-A 2009-131631 and JP-A 2014-90957 concerning halogenation treatment.

It is recommended that the core (hot-molded material) have a compressive hardness, or deflection, when compressed under a final load of 1,275 N (130 kgf) from an initial load of 98 N (10 kgf) which, although not particularly limited, is preferably at least 2.0 mm, more preferably at least 2.5 mm, and even more preferably at least 2.7 mm. The upper limit is preferably not more than 5.5 mm, more preferably not more than 5.0 mm, and even more preferably not more than 4.8 mm. When the core deflection is larger than this value, the core becomes too soft, as a result of which the durability of the ball to impact may worsen. On the other hand, when the core deflection is smaller than this value, a ball spin rate-lowering effect cannot be obtained and the feel at impact may become hard.

The core has a diameter which, although not particularly limited, depends also on the layer construction of the golf ball that is produced. The diameter is preferably at least 30 mm, and more preferably at least 35 mm. The upper limit is preferably not more than 41 mm, and more preferably not more than 40 mm. When the core diameter falls outside of this range, the initial velocity of the ball may decrease or suitable spin properties may not be obtained.

The core has an initial velocity which, in order to provide low-rebound balls, is preferably 76.5 m/s or less, The initial velocity of the core can be measured using an initial velocity measuring apparatus of the same type as the USGA drum rotation-type initial velocity instrument approved by the R&A. The core is tested in a chamber at a room temperature of 23.9±2° C. The core is struck using a 250-pound (113.4 kg) head (striking mass) at an impact velocity of 143.8 ft/s (43.83 m/s), and the time taken for it to traverse a distance of 6.28 ft (1.91 m) is measured and used to compute the initial velocity (m/s). Regarding the measurement environment for the above initial velocity measuring apparatus, the core to be measured is held isothermally for at least three hours in a thermostatic chamber adjusted to 0° C., 24° C. or 40° C. and is then measured at a room temperature of 23.9±2° C.

The cover material is not particularly limited; a known resin material such as any of various ionomer resins or a thermoplastic polyurethane elastomer or other urethane used in golf balls may be employed.

To obtain the above cover, use can be made of, for example, a method in which, depending on the type of ball being produced, a pre-fabricated single-layer core or multilayer core of two or more layers is placed in a mold and the above mixture is mixed and melted under heating and then injection-molded over the core, thereby encasing the core with the desired cover. Another method that may be used to form the cover involves molding the cover material of the invention into a pair of hemispherical half-cups, enclosing the core with these half-cups, and then molding under applied pressure at between 120° C. and 170° C. for a period of from 1 to 5 minutes.

The thickness of the cover may be set to from 0.3 to 3.0 mm, and may be preferably set in a range of from 0.5 to 2.0 mm. The Shore D hardness of the cover, although not particularly limited, is set to preferably 40 or more, and more preferably 45 or more. The upper limit is preferably 70 or less, and more preferably 65 or less.

Numerous dimples may be formed on the surface of the outermost layer of the cover. Also, various types of treatment, such as surface preparation, stamping and painting, may be carried out on the cover.

No particular limitation is imposed on the type of golf ball, so long as it is one having a core and a cover of at least one layer. For example, the golf ball may be a two-piece or three-piece solid golf ball having a solid core encased by a cover.

It is desirable for this invention to be utilized particularly in practice golf balls. With regard to the ball construction, the ball is preferably a two-piece golf ball having a single-layer core and a single-layer cover. Moreover, the cover is preferably formed of a urethane resin such as a thermoplastic polyurethane elastomer.

The golf ball of the invention, in order to provide low-rebound balls such as practice golf balls, has an initial velocity of 75 m/s or less, preferably 74 m/s or less. The initial velocity of the ball is a value measured with a COR initial velocity tester of the same type as a R&A tester. Specifically, a COR initial velocity tester manufactured by Hye Precision Products (U.S.A.) is used. At the time of measurement, the air pressure is changed in four stages and measurement is carried out, based on which a formula relating the inbound velocity and the COR is established and the initial velocity at an inbound velocity of 43.83 m/s is determined. Measurement with this COR initial velocity tester is carried out at a room temperature of 23.9±2° C. using as the sphere being tested a ball that has been held isothermally for at least 3 hours in a thermostatic chamber adjusted to 0° C., 24° C. or 40° C. The barrel diameter is selected such that the clearance on one side with respect to the outside diameter of the sphere being measured falls in a range of from 0.2 to 2.0 mm.

In this invention, the ball has a difference between the initial velocities at 0° C. and 24° C. of 2.0 m/s or less, preferably 1.5 m/s or less, and more preferably 1.2 m/s or less. The purpose is to minimize the decrease in initial velocity with changes in temperature.

In order to maintain the feel of the ball at impact, the golf ball of the invention has a specific gravity of 1.0 or more, and preferably 1.1 or more. The upper limit is preferably not more than 1.2.

It is recommended that the golf ball have a compressive hardness, or deflection, when compressed under a final load of 1,275 N (130 kgf) from an initial load of 98 N (10 kgf) which, although not particularly limited, is preferably at least 2.0 mm, more preferably at least 2.5 mm, and even more preferably at least 2.7 mm. The upper limit is preferably not more than 5.5 mm, more preferably not more than 5.0 mm, and even more preferably not more than 4.5 mm. At a ball deflection larger than this value, the ball becomes too soft, as a result of which the durability to impact may worsen. On the other hand, at a ball deflection smaller than this value, a ball spin rate-lowering effect cannot be obtained and the feel at impact may become hard.

### EXAMPLES

The following Examples and Comparative Examples are provided to illustrate the invention and are not intended to limit the scope thereof.

### Examples 1 to 4, Comparative Examples 1 to 6

Using core materials in which the chief ingredient is the polybutadiene shown in Table 1 below, rubber compositions were prepared according to the rubber formulations for Examples 1 to 4 and Comparative Examples 1 to 6. The compositions were vulcanized for 20 minutes at 155° C. and a core surface abrasion step was carried out, thereby producing cores having a diameter of about 39.9 mm.

TABLE 1

| Core formulation | | Specific | Comparative Example | | | | | | Example | | | |
|---|---|---|---|---|---|---|---|---|---|---|---|---|
| (pbw) | | gravity | 1 | 2 | 3 | 4 | 5 | 6 | 1 | 2 | 3 | 4 |
| (a) | UBEPOL VCR 617 | 0.91 | 100 | 0 | 0 | 0 | 0 | 0 | 35 | 42 | 50 | 100 |
| | BR 01 | 0.91 | 0 | 100 | 100 | 20 | 90 | 80 | 65 | 58 | 50 | 0 |
| | SBR 1507 | 0.94 | 0 | 0 | 0 | 80 | 0 | 0 | 0 | 0 | 0 | 0 |
| | RIIR 365 | 0.92 | 0 | 0 | 0 | 0 | 10 | 0 | 0 | 0 | 0 | 0 |
| | BIIR 2222 | 0.92 | 0 | 0 | 0 | 0 | 0 | 20 | 0 | 0 | 0 | 0 |
| (c) | ZnO | 5.57 | 1.0 | 3.4 | 2.5 | 7.8 | 1.0 | 1.0 | 2.9 | 2.5 | 6.2 | 1.0 |
| | BaSO₄ | 4.45 | 0 | 7 | 0 | 0 | 0 | 0 | 0 | 0 | 0 | 0 |
| | Silica | 1.95 | 0 | 0 | 17 | 24.1 | 20 | 20 | 20 | 20 | 14 | 35 |
| — | Hi-Zex Million ™ | 0.935 | 30 | 0 | 0 | 0 | 0 | 0 | 0 | 0 | 0 | 0 |
| | 630M | | | | | | | | | | | |
| (b) | ZDA | 1.7 | 12 | 32 | 28 | 26 | 27 | 27 | 22 | 23 | 22 | 8.5 |
| — | WM23 | 1.08 | 0.1 | 0.1 | 0.1 | 0.1 | 0.1 | 0.1 | 0.1 | 0.1 | 0.1 | 0.1 |
| (d) | PO: DCP | 1.02 | 0.6 | 0.6 | 0.6 | 0.6 | 0.6 | 0.6 | 0.6 | 0.6 | 0.6 | 1.0 |
| | PO: C40 | 1.54 | 0.6 | 0.6 | 0.6 | 0.6 | 0.6 | 0.6 | 0.6 | 0.6 | 0.6 | 0 |

| | | | | | | | | | | |
|---|---|---|---|---|---|---|---|---|---|---|
| Specific gravity of formulation | 0.96 | 1.09 | 1.09 | 1.09 | 1.09 | 1.09 | 1.09 | 1.09 | 1.09 | 1.09 |
| Volumetric ratio (%) of (c) filler | 24. | 1.7 | 6.7 | 7.2 | 7.6 | 7.6 | 8.0 | 7.9 | 6.3 | 13.6 |
| Proportion (%) of | 17.0 | 0 | 0 | 0 | 0 | 0 | 6.0 | 7.1 | 8.5 | 17.0 |
| syndiotactic 1,2-polybutadiene | | | | | | | | | | |
| in base rubber | | | | | | | | | | |

Details on the above compounding ingredients are given below.
UBEPOL VCR617: A polybutadiene rubber (syndiotactic 1,2-polybutadiene content in polybutadiene, 17 wt %) from UBE Elastomer Co., Ltd.
BR 01: A high-cis polybutadiene rubber from ENEOS Material
SBR 1507: A styrene-butadiene rubber from ENEOS Material
RIIR 365: A regular butyl rubber from ENEOS Material
BIIR 2222: A brominated butyl rubber from ENEOS Material
ZnO: Available as “Grade 3 Zinc Oxide” from Sakai Chemical Co., Ltd.
BaSO₄: Baryte powder (from Hakusui Tech)
Silica: Precipitated silica available as Nipsil® AQ from Tosoh Silica Corporation
Hi-Zex Million™ 630M: Ultra-high molecular weight polyethylene fine particles (Mitsui Chemicals, Inc.)
ZDA: 85 wt % zinc acrylate/15 wt % zinc stearate (Nippon Shokubai Co., Ltd.)
WM 23: A hindered phenol-type antioxidant, available as Nocrac NS-6 from Ouchi Shino Chemical Industry Co., Ltd.
PO:DCP: Dicumyl peroxide, available as Percumyl D from NOF Corporation
PO:C40: Mixture of 1,1-di (t-butylperoxy) cyclohexane and silica, available as Perhexa C-40 from NOF Corporation

Next, a thermoplastic polyurethane elastomer (available under the trade name Pandex from DIC Bayer Polymer; Shore D material hardness, 49) was injection-molded over the above core, forming a 1.4 mm thick cover. In addition, the cover was painted with a urethane resin composition, producing a two-piece golf ball.

The compressive deformation (deflection) and initial velocity of the core and the ball in each of the above Examples and Comparative Examples were evaluated by the methods described below. The results are shown in Table 2.

### Compressive Deformation (Deflection) of Core and Ball

The compressive deformations (mm) of the cores and the balls when compressed at a speed of 10 mm/s to a final load of 1,275 N (130 kgf) from an initial load state of 98 N (10 kgf) were measured at temperatures of 0° C., 24° C. and 40° C. The average value for ten measured spheres was determined in each case.

### Core Initial Velocity

The initial velocity of the core was measured using an initial velocity measuring instrument of the same type as the USGA drum rotation-type initial velocity tester approved by the R&A. The core was tested in a chamber at a room temperature of 23.9±2° C. The core was struck using a 250-pound (113.4 kg) head (striking mass) at an impact velocity of 143.8 ft/s (43.83 m/s), and the time taken for it to traverse a distance of 6.28 ft (1.91 m) was measured and used to compute the initial velocity (m/s). Regarding the measurement environment for the above initial velocity measuring apparatus, the cores to be measured were held isothermally for at least three hours in a thermostatic chamber adjusted to 0° C., 24° C. or 40° C. and were then measured at a room temperature of 23.9±2° C.

### Ball Initial Velocity

A COR initial velocity tester manufactured by Hye Precision Products (U.S.A.) was used to measure the initial velocity of the ball. At the time of measurement, the air pressure was changed in four stages and measurement was carried out, based on which a formula relating the inbound velocity and the COR was established. The initial velocity at an inbound velocity of 43.83 m/s was determined from this formula. Measurement with this COR initial velocity tester was carried out at a room temperature of 23.9±2° C. using as the sphere being tested a ball that was held isothermally for at least 3 hours in a thermostatic chamber adjusted to 0° C., 24° C. or 40° C. The barrel diameter was selected such that the clearance on one side with respect to the outside diameter of the sphere being measured fell in a range of from 0.2 to 2.0 mm.

### Evaluation of Change in Initial Velocity and Change in Deflection at Low Temperature

(1) Regarding the ball initial velocity, an initial velocity at 24° C. below 75 m/s was rated as “Good”; an initial velocity at 24° C. of 75 m/s or more was rated as “NG.”

(2) Regarding the change in initial velocity at low temperature, a decrease in initial velocity with a change in temperature from 24° C. to 0° C. of less than 1.2 m/s was rated as “Good”; a decrease of 1.2 m/s or more was rated as “NG.”

(3) Regarding the change in deflection at low temperature, a change in deflection with a change in temperature from 24° C. to 0° C. of less than 0.2 mm was rated as “Good”; a change of 0.2 mm or more was rated as “NG.”

TABLE 2

| | | | Comparative Example | | | | | | Example | | | |
|---|---|---|---|---|---|---|---|---|---|---|---|---|
| | | | 1 | 2 | 3 | 4 | 5 | 6 | 1 | 2 | 3 | 4 |
| Core | Deflection (mm) | 0° C. | 2.37 | 2.54 | 2.71 | 2.53 | 2.73 | 2.75 | 2.74 | 2.54 | 2.61 | 2.68 |
| | | 24° C. | 2.72 | 2.64 | 2.75 | 2.69 | 2.80 | 2.84 | 2.83 | 2.64 | 2.73 | 2.88 |
| | | 40° C. | 2.97 | 2.66 | 2.80 | 2.76 | 2.84 | 2.88 | 3.05 | 2.84 | 2.95 | 3.18 |
| | Initial velocity (m/s) | 0° C. | 70.00 | 76.88 | 75.52 | 70.57 | 72.51 | 70.06 | 74.00 | 73.97 | 73.84 | 70.36 |
| | | 24° C. | 72.10 | 78.11 | 76.44 | 73.92 | 74.25 | 72.73 | 74.85 | 74.78 | 74.86 | 71.11 |
| | | 40° C. | 72.60 | 78.52 | 76.67 | 74.15 | 75.12 | 73.58 | 75.72 | 75.44 | 75.55 | 71.80 |
| Ball | Diameter (mm) | | 42.73 | 42.75 | 42.74 | 42.75 | 42.75 | 42.74 | 42.74 | 42.75 | 42.75 | 42.74 |
| | Weight (g) | | 40.28 | 45.65 | 45.61 | 45.61 | 45.65 | 45.58 | 45.61 | 45.61 | 45.57 | 45.58 |
| | Specific gravity | | 0.99 | 1.12 | 1.12 | 1.12 | 1.12 | 1.12 | 1.12 | 1.11 | 1.11 | 1.12 |
| | Deflection (mm) | 0° C. | 2.36 | 2.53 | 2.60 | 2.52 | 2.72 | 2.74 | 2.71 | 2.52 | 2.60 | 2.67 |
| | | 24° C. | 2.71 | 2.63 | 2.68 | 2.68 | 2.80 | 2.84 | 2.82 | 2.62 | 2.72 | 2.88 |
| | | 40° C. | 2.97 | 2.65 | 2.78 | 2.75 | 2.84 | 2.88 | 2.99 | 2.79 | 2.95 | 3.18 |
| | Initial velocity (m/s) | 0° C. | 69.70 | 74.97 | 73.98 | 70.13 | 71.62 | 69.74 | 72.76 | 72.67 | 72.64 | 69.97 |
| | | 24° C. | 71.61 | 76.22 | 75.01 | 73.00 | 73.26 | 72.09 | 73.75 | 73.59 | 73.73 | 70.85 |
| | | 40° C. | 72.29 | 76.83 | 75.47 | 73.48 | 74.22 | 73.04 | 74.24 | 74.07 | 74.55 | 71.68 |

| | | | | | | | | | | | |
|---|---|---|---|---|---|---|---|---|---|---|---|
| Evaluations | Evaluation | Good | NG | NG | Good | Good | Good | Good | Good | Good | Good |
| | (initial velocity of ball) | | | | | | | | | | |
| | Change in initial velocity at | −1.91 | −1.24 | −1.02 | −2.87 | −1.63 | 2.35 | −0.99 | −0.92 | −1.08 | −0.88 |
| | low temperature ΔVi (0° C.-24° C.) | | | | | | | | | | |
| | Evaluation | NG | NG | Good | NG | NG | NG | Good | Good | Good | Good |
| | (large decrease: NG; | | | | | | | | | | |
| | small decrease: Good) | | | | | | | | | | |
| | Change in deflection at | −0.36 | −0.10 | −0.08 | −0.16 | −0.08 | −0.10 | −0.11 | −0.10 | −0.12 | −0.20 |
| | low temperature Δμ (0° C.-24° C.) | | | | | | | | | | |
| | Evaluation | NG | Good | Good | Good | Good | Good | Good | Good | Good | Good |
| | (large decrease: NG; | | | | | | | | | | |
| | small decrease: Good) | | | | | | | | | | |

As shown in Table 2, in each of Examples 1 to 4 according to the invention, it was possible to lower the initial velocity of the ball. In addition, the change in initial velocity and the change in deflection with respect to temperature changes were small. That is, the golf balls in these Examples underwent little change in their physical properties at low temperature, and so it was found that a close-to-normal ball performance can be obtained even at a low temperature.

By contrast, in Comparative Example, 1, the core was formed of a rubber composition in which the volumetric ratio of the inorganic filler (c) exceeded 14 vol %. Although a decrease in the ball initial velocity was achieved, the change in deflection with a change in temperature was large. Also, the specific gravity of the golf ball in Comparative Example 1 was lower than 1.1. Hence, the ball had a reduced specific gravity and a lower weight, and the feel at impact was poor.

In Comparative Example 2, the core was formed of a rubber composition which contained no syndiotactic 1,2-polybutadiene in the base rubber (a) and used only high-cis polybutadiene rubber, and in which the volumetric ratio of the inorganic filler (c) was less than 5 vol %. A decrease in the initial velocity of the ball was not achieved, and so a golf ball having the lower rebound intended could not be obtained.

In Comparative Example 3, the core was formed of a rubber composition which contained no syndiotactic 1,2-polybutadiene as the base rubber (a) and used only high-cis polybutadiene rubber. A decrease in the initial velocity of the ball was not achieved, and so a golf ball having the lower rebound intended could not be obtained.

In Comparative Example 4, the core was formed of a rubber composition containing, as the base rubber (a), a large amount of styrene-butadiene rubber (SBR). Although a decrease in the ball initial velocity was achieved, the decrease in initial velocity with a change in temperature was large.

In Comparative Example 5, the core was formed of a rubber composition containing, as the base rubber (a), high-cis polybutadiene rubber and a small amount of butyl rubber. Although a decrease in the initial velocity of the ball was achieved, the decrease in initial velocity with a change in temperature was large.

In Comparative Example 6, the core was formed of a rubber composition containing, as the base rubber (a), high-cis polybutadiene rubber and a small amount of bromobutyl rubber. Although a decrease in the ball initial velocity was achieved, the decrease in initial velocity with a change in temperature was large.

Japanese Patent Application No. 2023-195997 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A golf ball comprising a core and a cover of at least one layer encasing the core, wherein the core is formed of a rubber composition which includes:
(a) a base rubber,
(b) a co-crosslinking agent which is an α,β-unsaturated carboxylic acid or a metal salt thereof or both,
(c) a filler, and
(d) a crosslinking initiator,
the base rubber (a) has a polybutadiene content of at least 90 wt % and a syndiotactic 1,2-polybutadiene content of from 5 to 30 wt %, the amount of filler (c) included is from 6 to 14 vol % of the rubber composition, and the ball has a specific gravity of 1.0 or more and an initial velocity of 75 m/s or less.

2. The golf ball of claim 1, wherein the ball has a difference between the initial velocities at 0° C. and 24° C. of 2.0 m/s or less.

3. The golf ball of claim 1, wherein the filler (c) is an inorganic filler.

4. The golf ball of claim 3, wherein the inorganic filler is one or more selected from the group consisting of zinc oxide, barium sulfate, calcium carbonate and silicon dioxide (silica).

5. The golf ball of claim 4, wherein the inorganic filler is silicon dioxide (silica) and further includes a silane coupling agent.

6. The golf ball of claim 5, wherein the silane coupling agent is an alkoxy group-containing silane coupling agent.

7. The golf ball of claim 1, wherein the base rubber (a) includes a silane-modified diene rubber.

8. The golf ball of claim 1, wherein the rubber composition further includes (e) a hindered phenol-type antioxidant.

9. The golf ball of claim 1, wherein the cover has an outermost layer that is formed of a resin composition composed primarily of a urethane resin or an ionomer resin.

10. The golf ball of claim 1 which is a two-piece golf ball comprising a single-layer core and a single-layer cover, wherein the cover is formed of a urethane resin and the core is a halogenation-treated core.

11. The golf ball of claim 1, wherein the syndiotactic 1,2-polybutadiene includes syndiotactic 1,2-polybtadiene having a melting point of 150° C. or more.

12. The golf ball of claim 1, wherein the syndiotactic 1,2-polybutadiene is dispersed in a fibrous manner within the core.
